(19) United States
(12) Patent Application Publication
(10) Pub. No.: US 2014/0255659 A1
(43) Pub. Date: Sep. 11, 2014

(54) PLASTIC FLOOR COVERING

(71) Applicant: Ulrich Windmöller, Schloss Holte-Stukenbrock (DE)

(72) Inventor: Ulrich Windmöller, Schloss Holte-Stukenbrock (DE)

(73) Assignee: WPT GMBH, Detmold (DE)

(21) Appl. No.: 14/234,287

(22) PCT Filed: Oct. 31, 2011
(86) PCT No.: PCT/EP2011/005493

§ 371 Date: Jan. 22, 2014

(51) Int. Cl. E04F 15/10; B32B 38/10; B32B 38/00

(52) U.S. Cl. CPC E04F 15/105; E04F 15/107; B32B 38/00; B32B 38/10
USPC 428/193; 428/221; 428/215; 428/342; 156/182

(57) ABSTRACT

An elastic floor covering 10, includes a soft core 18, a decor layer 14 on top of the core 18, a wear layer 12 on top of the decor layer 14 and a backside layer 20 positioned under the core 18, in which at least the core 18, the wear layer 12, and the backside layer 20 are made of polyurethane, and a glass fiber mat 16 is arranged between the core 18 and the decor layer, the decor layer 14 is made of cellulose paper impregnated with polyurethane, the wear layer 12 being made of polyurethane produced from aliphatic polyol, and the core 18 and the backside layer 20 being made of polyurethane produced from an aromatic polyol from renewable primary products.

The present invention relates to an elastic floor covering, comprising a soft core, a decor layer on top of the core, a transparent wear layer on top of the decor layer and a backside layer positioned under the core, wherein at least the core, the wear layer and the backside layer are made of polyurethane, and a glass fiber mat is arranged between the core and the decor layer.

Flexible floor coverings of plastic materials are commonly known. In the past, floor coverings were made, for example, from PVC or linoleum. Thermoplastic floor coverings, i.e. such floor coverings that are sufficiently deformable at room temperature, are sold as web product and can be installed by glueing onto the ground. It is also possible to produce such floor coverings in the form of panels or tiles that comprise locking profiles at their lateral edges providing a connection with a corresponding further panel or tile. The flexibility of such a floor covering does not only facilitate the installation but also leads to positive characteristics in use, for example, a good impact sound reduction.

The floor covering of the present kind has a laminate structure. It comprises a soft core, a decor layer provided on the core, a wear layer applied on top of the decor layer, and a backside layer arranged under the core. For some years floor coverings are known in which at least the core, the wear layer and the backside layer are made of polyurethane (PU). This provides different advantages, like, for example, a high dimensional stability, i.e. there are only small changes of the dimensions of the floor covering with varying temperature. Moreover, such a floor covering has good elastic properties. Deformations caused by mechanical load onto the surface restitute to almost 100%. Another important aspect is the environmental safety of such floor coverings, providing low emissions and being safe from discharging toxic gases in case of fire.

The polyol used as a precursor for the synthesis of the polyurethane of these floor coverings originated in most cases from petrochemical raw materials. The superior aliphatic Polyol is primarily used for the polyurethane of the wear layer, while the PU material for the core and the backside layer is usually produced from aromatic Polyol. The use of aliphatic polyol results in polyurethanes with high scratch resistance, cleaning friendliness, UV stability, impression behaviour, reshaping behaviour and improved characteristics in case of fire.

With more restrictive legal stipulations concerning the environmental safety, demanding an even higher environmental compatibility, there is an increasing demand in the market for products with excellent environmental safety in the living area. These requirements could not be fulfilled by the conventional floor coverings.

It is therefore an object of the present invention to improve a flexible floor covering with the above described laminate structure consisting predominantly or completely of polyurethane with respect to its characteristics, in particular to its environmental safety and its characteristics in case of fire to decrease its emissions. The excellent characteristics in use of the conventional floor coverings of PU shall not only be maintained but even improved, in particular with regard to its dimensional stability, its impression behaviour in case of a mechanical load and its reshaping behaviour.

These objects are achieved according to the present invention by a floor covering comprising the features of claim 1.

The core and the backside layer of the floor covering according to the present invention consist of polyurethane that is synthesized of aromatic polyol originating from renewable primary products. These are so called biogenic polyols. The polyurethanes made herefrom show improved characteristics with respect to their environmental friendliness, compared to polyol of petrochemical origin. In particular, they show low emissions and do not develop toxic gases in case of fire. For this reason it is possible to produce a flexible floor covering using polyurethane almost completely from renewable primary products and to satisfy the demand for environmentally compatible and sustainable products. The polyurethane of the wear layer is made of an aliphatic polyol, while the polyurethane of the core and the backside layer is synthesized of a biogenic aromatic polyol.

For further improvement of the dimensional stability, a glass fiber mat is positioned between the core and the decor layer, further improving the impression behaviour and the reshaping behaviour and inhibiting an extension and a shrinking of the floor covering with varying temperature. In the floor covering according to the present invention, the decor layer is made of a cellulose paper impregnated with polyurethane. This polyurethane can also be synthesized of a biogenic polyol.

According to a preferred embodiment of the present invention, the renewable primary products are plant oil, in particular castor oil, rapeseed oil or palm oil.

According to another preferred embodiment of the present invention, the backside layer comprises a surface structure at its bottom side. This provides a good connection to an additional adhesive used for glueing the floor covering onto a ground, like, for example, a floor screed.

According to still another preferred embodiment of the present invention, the core and the backside layer are made as one piece, both consisting of the same material. In this case the backside layer just represents the back surface of the core.

Preferably the backside layer is made of a polyol formulation that has affine characteristics with respect to common dispersion glue as commonly used for floor coverings.

More preferably, the wear layer has a thickness between 0.1 mm and 0.5 mm, the decor layer has a thickness of about 0.2 mm, and the glass fiber mat has a thickness between 0.2 mm and 0.5 mm. According to another preferred embodiment of the present invention, the cellulose paper of the decor layer has an area weight between 35 and 80 g/m².

According to another preferred embodiment of the present invention, the floor covering is produced as a rollable web product. Therefore it is possible to deliver the floor covering according to the present invention as a web product in the form of rolls that can be cut and glued in pieces at the installation site. This web product may preferably have a thickness of about 1 to 3 mm.

According to an alternative embodiment of the present invention, the floor covering can be cut to a panel comprising locking profiles at its lateral edges to be connected with other panels. In this case the floor covering is delivered in the form of floor panels provided with profiles to be connected with each other. This panel may preferably have a thickness between about 3 mm and 8 mm.

More preferably, the present invention refers to a floor element for installation on a floor, like a floor panel or a floor tile, comprising a support panel being covered with a floor covering according to the present invention. That is, the floor covering according to the present invention is supported at its bottom by a support panel in the present case. The support panel can be produced of a relatively inexpensive material like a derived timber product. The floor covering on the support panel may have a thickness of about 1 mm.

More preferably, the support panel of this floor element is provided with locking profiles at its lateral edges for connection with other panels. For this reason the installation is carried out by mutual collection of the locking profiles, as with conventional floor panels.

A method for producing a floor covering according to the present invention is characterized by the first process for producing an upper laminate comprising the wear layer, the decor layer and the glass fiber mat, and by a second process for producing the core and the backside layer, as well as by joining the upper laminate and the core. The first process comprises the following steps:
a) applying a layer of polyurethane produced from an aliphatic polyol to a first support web for forming the wear layer,
b) applying a cellulose paper web for forming the decor layer to the wear layer,
c) applying a glass fiber mat web to the cellulose paper web,
d) impregnating the cellulose paper web and the glass fiber mat web with polyurethane.

The second process comprises the step of applying a layer of polyurethane produced from a biogenic aromatic polyol to a surface structured second support web for forming the backside layer and a core.

Preferably the first process comprises, subsequent to step d), removing the first support web, and tempering the upper laminate.

According to another preferred embodiment of the method according to the present invention, the second process comprises, subsequent to the step of forming the backside layer and the core, a step of applying a covering adhesive to the core. By this step the core is prepared for joining the upper laminate.

More preferably, after the step of applying the covering adhesive to the core, the upper laminate is glued onto the core.

In the following a preferred embodiment of the present invention is described in more detail with reference to the following figures.

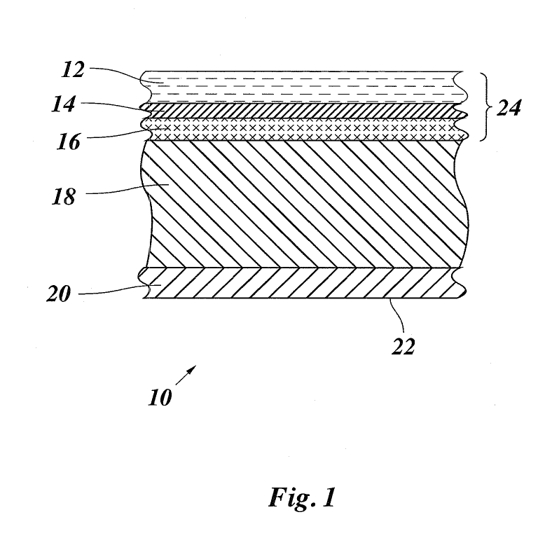

FIG. 1 shows a schematic section through the laminate structure of one embodiment of the elastic floor covering according to the present invention, and

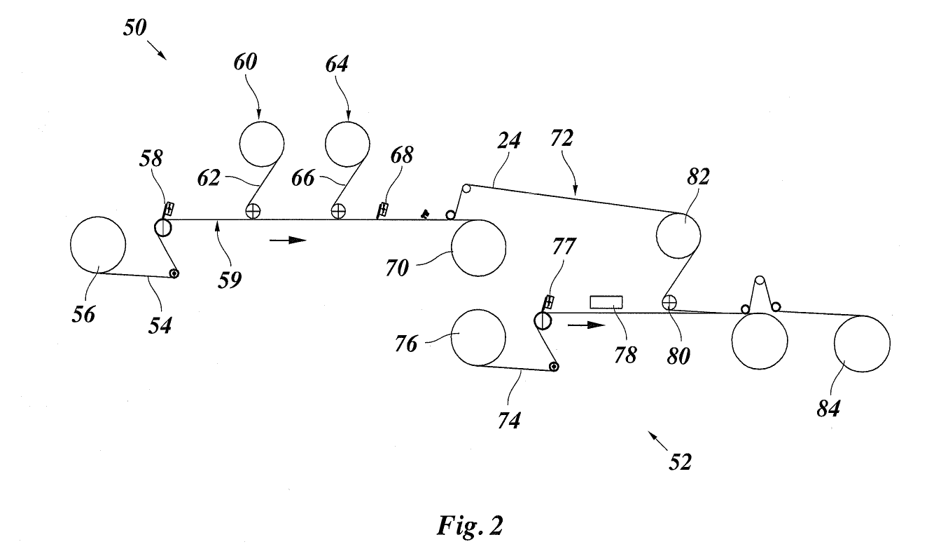

FIG. 2 is a schematic view of a method for producing the floor covering according to the present invention.

The section in FIG. 1 shows a floor covering 10 with a laminate structure. It comprises (from top to bottom) a transparent wear layer 12 forming the upper surface of the floor covering 10, a decor layer 14 positioned under the wear layer 12, showing a decor, a glass fiber mat 16 under the decor layer 14, a soft core 18 and a backside layer 20 finishing the laminate structure of the floor covering 10 to its bottom side. Details of this laminate structure shall be described in the following.

The wear layer 12 is made completely of polyurethane (PU) that is synthesized from a superior aliphatic polyol. This aliphatic polyol is biogenic polyol. Moreover this wear layer 12 shows a high scratch resistance, cleaning friendliness, UV stability, a good impression behaviour and reshaping behaviour and no emissions of toxic gases in case of fire. The impression behaviour shall describe the behaviour of the material in case of a mechanical load. The surface of the floor covering 10 shows a high resistance against such loads. If impressions are formed, they reshape almost completely if the mechanical load is removed.

In the present embodiment, the wear layer 12 shows a thickness between 0.1 and 0.5 mm.

The decor film 14 positioned under the wear layer 12 is made of a decor paper, which is a cellulose paper impregnated with polyurethane. This polyurethane can also be synthesized from a biogenic polyol, i.e. originating from a renewable primary product. The decor paper may have an area weight between 35 and 80 g/m², being printed with a decor on its upper side.

For improving the dimensional stability and for further improvement of the impression behaviour and reshaping behaviour of the floor covering 10, the laminate structure further comprises a glass fiber mat 16 arranged between the decor layer 14 and the core 18 below. This glass fiber mat is also impregnated with polyurethane produced from a biogenic polyol. It has a thickness between 0.2 mm and 0.5 mm.

The core 18 as well as the backside layer 20 each are made of a polyurethane produced from an aromatic polyol from renewable primary products. Aromatic polyol is less superior than aliphatic polyol, but since the core 18 and the backside layer 20 are not exposed to the upper surface of the floor covering 10, the use of materials is acceptable for this purpose that are less superior. However, the core 18 has still good characteristics with respect to its environmental compatibility, has low emissions and does not set free toxic gases in case of fire. The core 18 may comprise additional filler materials.

The backside layer 20 may comprise a surface structure on its bottom side 22 that promotes the adhesion with a glue. This means that the floor covering 10 can be glued to a ground without problems. The floor covering 10 described here can be glued directly to a floor screed.

In alternative embodiments it is possible to install the floor covering 10 not directly to the ground but on top of a support panel. The result is a floor panel or a floor tile that is covered with the floor covering according to the present invention, and it can be installed like conventional floor panels, for example by means of locking profiles positioned at the lateral edges of the panels.

According to still another embodiment, it is possible to provide the floor covering 10 as such as a floor panel providing a certain degree of flexibility and elasticity. This floor panel can also be provided with lateral locking profiles.

More specific embodiments are described in the following.

### EMBODIMENT 1

This embodiment is a floor element for installation on a floor, comprising a bottom support plate of a derived timber product like chipboard, medium density fiber board or high density fiber board. It is also possible to make a support panel of a plastic material. On its upper surface, the support panel is covered with the floor covering 10 according to the present invention like shown in the Figure and described above. The backside layer 20 of this floor covering 10 is glued onto the support panel.

The floor covering 10 on the top side of the support panel has a thickness of about 1 mm.

### EMBODIMENT 2

This embodiment is a floor covering 10 produced as a rollable web product that can be delivered in rolled state and glued to the ground. This floor covering 10 has an overall thickness of 1.8 to 3 mm.

### EMBODIMENT 3

This embodiment is an elastic floor panel being formed completely by the floor covering 10 itself, and its upper surface being formed by the wear layer 12 while its bottom surface 22 is formed by the backside layer 20. These panels are provided with locking profiles at their lateral edges, like, for example, profiles for an adhesive free installation. These panels have an overall thickness of 3 to 8 mm and may have a width of about 2 m, and they can be cut at different lengths and into different widths.

FIG. 2 shows schematically a method for producing the floor covering 10, for example, as a rollable web product.

This method is divided in two different processes that can be carried out at the same time. In the first process, the wear layer 12 and the decor layer 14 are produced and joined with the glass fiber mat 16 to form a laminate structure that is designated in FIG. 1 with reference number 24. In the second process, the core 18 and the backside layer 20 are produced. In the following, the parts of the floor covering 10 produced in the two processes are joined to one unit, for example, by gluing, so that the upper laminate structure 24 is glued onto the core 18.

In FIG. 2, the first process 50 is shown schematically in the upper portion of the Figure, while the second process 52 is shown in the lower portion of the Figure. In the first process 50 a first support web 54 is unreeled from a roll 56 and guided to a station 58 for applying a polyurethane layer to the support web 54. The polyurethane of this layer is produced from a superior aliphatic polyol. Within the station 58, the polyurethane layer is applied to the support web 54 in the desired thickness by means of a doctor blade. The resulting polyurethane layer forms the wear layer 12 of FIG. 1.

The support web 54 carrying the wear layer 12 is covered subsequently in the next station 60 with a cellulose paper web 62. Before it reaches station 60, the wear layer 12 crosses a heating station 59. It is noted that in this process, the wear layer 12 is positioned downside, i.e. the side corresponding to its position in use according to FIG. 2, forming the use surface, faces the support web 54. The layering sequence in the first process is from top to bottom with respect to the orientation in FIG. 1, i.e. the wear layer 12 is formed first, and subsequently the decor layer 14 and the glass fiber mat 16 are applied.

In the following station 64, the glass fiber mat 66 is unreeled from a roll and positioned on the cellulose paper web 62 so that the wear layer 12, the cellulose paper web 62 for forming the decor layer 14 and the glass fiber mat web 66 are layered on the support web 54. This laminate structure is transmitted further to station 68, in which the cellulose paper web 62 and the glass fiber mat web 66 are impregnated with polyurethane. This is performed by a doctor blade with a rubber lip for introducing the polyurethane into the glass fiber mat web and the cellulose paper web.

The resulting laminate structure 24 is then separated from the support web 54, which is wounded onto a roll. After the delimitation, the laminate structure 24 runs through a tempering station 72 to bring it to a predetermined temperature.

In the second process 52, a second support web 74 is unreeled from a roll 76. This support web 74 is provided with a surface structure. It runs through a station 77 in which a layer of polyurethane is applied to the support web 74 with the surface structure, said polyurethane originating from a biogenic aliphatic polyol, which is a polyol from renewable primary products. The layer applied within the station 77 forms the core and the backside layer 20. In the present embodiment, the backside layer 20 is formed only by the structured bottom side of the core 18, i.e. the core 18 and the backside layer 20 are made as one piece.

The support web 74 carries the core 18 with the backside layer 20 further into station 78, in which an adhesive glue is applied to the upper side of the core 18.

Downstream to station 78, a laminate cylinder 80 is provided to laminate the laminate structure 24 from the first process 50 onto the upper side of the core 18 provided with adhesive. It is noted that the laminate structure 24 can be wound up intermediately and unreeled for the laminating process described here, which is not shown in FIG. 2. However, it is also possible to transfer the laminate structure 24 directly after crossing the cooling section 72 via deflection roll or comparable means to the laminate cylinder 80. Such a deflection roll is shown schematically in FIG. 2. In the real process, this deflection also comprises the turning of the laminate structure 24 into the right orientation, which is also not demonstrated here.

Downstream to the laminating cylinder 80, the structured support web 24 is wounded up again and separated from the resulting floor covering 10. The floor covering 10 is then wound up onto a roll 84 as a web product.

What is claimed is:

1. Elastic floor covering, comprising a soft core, a decor layer on top of the core, a wear layer on top of the decor layer and a backside layer positioned under the core, wherein at least the core, the wear layer and the backside layer are made of polyurethane, and a glass fiber mat is arranged between the core and the decor layer, and wherein:
the decor layer is made of cellulose paper impregnated with polyurethane,
the wear layer is made of polyurethane produced from aliphatic polyol,
and the core and the backside layer are made of polyurethane produced from an aromatic polyol from renewable primary products.

2. Floor covering according to claim 1, wherein the renewable primary products are formed from plant oil.

3. Floor covering according to claim 1, wherein the backside layer comprises a surface structure at a bottom side thereof.

4. Floor covering according to claim 1, wherein the core and the backside layer are made as one piece, both formed of the same material.

5. Floor covering according to claim 1, wherein the backside layer is made of a polyol formulation that has affine characteristics with respect to a common dispersion glue.

6. Floor covering according to claim 1, wherein the wear layer has a thickness between 0.1 mm and 0.5 mm, the decor layer has a thickness of about 0.2 mm, and the glass fiber mat has a thickness between 0.2 mm and 0.5 mm.

7. Floor covering according to claim 1, wherein the cellulose paper of the decor layer has an area weight between 35 and 80 g/m².

8. Floor covering according to claim 1, wherein the floor covering is produced as a rollable web product.

9. Floor covering according to claim 1, wherein the floor covering is cut to a panel comprising locking profiles at lateral edges thereof to be connected with other panels.

10. Floor element for installation on a floor, comprising a support panel being covered with a floor covering according to claim 1.

11. Floor element according to claim 10, wherein the support panel is provided with locking profiles at lateral edges thereof for connection with other panels.

12. Method for producing a floor covering according to claim 1, comprising the steps of:
a first process for producing an upper laminate comprising the wear layer, the decor layer and the glass fiber mat, and
a second process for producing the core and the backside layer, and by joining the upper laminate and the core,
wherein the first process comprises the following steps:
a) applying a layer of polyurethane produced from an aliphatic polyol to a first support web for forming the wear layer,
b) applying a cellulose paper web for forming the decor layer to the wear layer,
c) applying a glass fiber mat web to the cellulose paper web, and
d) impregnating the cellulose paper web and the glass fiber mat web with polyurethane, and
the second process comprises the following step:
e) applying a layer of polyurethane produced from a biogenic aromatic polyol to a surface-structured second support web for forming the backside layer and the core.

13. Method according to claim 12, wherein the first process comprises the following further steps subsequent to step d):
f) removing the first support web and
g)tempering the upper laminate.

14. Method to claim 12, wherein the second process comprises the following step subsequent to step e):
h) applying a covering adhesive to the core.

15. Method according to claim 14, further comprising the step, after step h), of gluing the upper laminate onto the core.

16. Floor covering according to claim 2, wherein the plant oil is selected from the group consisting of castor oil, rapeseed oil and palm oil.
